(19) United States
(12) Patent Application Publication
(10) Pub. No.: US 2013/0108340 A1
(43) Pub. Date: May 2, 2013

(54) PRINTING APPARATUS

(71) Applicant: Sharp Kabushiki Kaisha, Osaka (JP)

(72) Inventor: Hirotsugu AKAMATSU, Osaka-shi (JP)

(73) Assignee: SHARP KABUSHIKI KAISHA, Osaka (JP)

(21) Appl. No.: 13/666,207

(22) Filed: Nov. 1, 2012

(30) Foreign Application Priority Data
Nov. 1, 2011 (JP) 2011-240181

(51) Int. Cl. G03G 15/20

(52) U.S. Cl. 399/341

(57) ABSTRACT

The present invention provides a printing apparatus that performs gloss finish treatment on at least a partial region of paper on which an image has been printed, including a gloss finish treatment adding portion that, when subsequently performing gloss finish treatment on paper, additionally performs gloss finish treatment on a partial region of the paper excluding any gloss-finished region.

### CROSS-REFERENCE TO RELATED APPLICATION

This application claims priority under 35 U.S.C. §119(a) on Patent Application No. 2011-240181 filed in Japan on Nov. 1, 2011, the entire contents of which are herein incorporated by reference.

### TECHNICAL FIELD

The present invention relates to a printing apparatus that performs gloss finish treatment on paper on which an image has been printed.

### BACKGROUND ART

As examples of this type of gloss finish treatment, there is gloss finish treatment using clear toner and gloss finish treatment using a coating film. As disclosed in JP 2010-175968A (hereinafter, referred to as Patent Document 1), gloss finish treatment using clear toner is performed as follows. That is, in an electrophotographic image forming apparatus, clear toner is attached to a photosensitive drum, transferred from the photosensitive drum to paper, and then fixed to the paper so that the clear toner layer is fixed to the paper surface, and, thus, gloss finish treatment is performed on the paper.

Incidentally, gloss finish treatment using a coating film is performed as follows. That is, a multi-layered coating film is overlaid on paper, and only a coating resin layer in the coating film is brought into close contact with the paper and is caused to coat the paper, and, thus, gloss finish treatment is performed on the paper.

This sort of gloss finish treatment is advantageous in that, after an image is formed by printing on non-glossy plain paper, only a necessary portion of the plain paper can be subjected to gloss finish treatment. For example, it is possible to perform gloss finish treatment on a photograph-printed region of the plain paper, while not performing gloss finish treatment on a text-printed region of the plain paper. In Patent Document 1, a region of paper is designated for treatment, and gloss finish treatment using clear toner is performed only on this designated region.

Incidentally, in the case where gloss finish treatment is performed only on a designated region as described above, another region targeted for gloss finish treatment may have to be added. For example, assume that gloss finish treatment has been performed on a photograph region printed on one sheet of paper, but gloss finish treatment has not been performed on a logo region printed on the paper. In this case, if there is a request for gloss finish treatment on the logo region, this logo region has to be also subjected to gloss finish treatment.

However, conventionally, an operation that adds a region targeted for gloss finish treatment is not aided at all, and the adding operation is complicated. Thus, gloss finish treatment may be repeatedly performed on the same region of paper due to erroneous operations or designations, and the image quality of this region may significantly deteriorate.

The present invention was made in view of such a conventional problem, and it is an object thereof to provide a printing apparatus in which gloss finish treatment is prevented from being repeatedly performed on the same region of paper.

### SUMMARY OF INVENTION

In order to solve the above-described problem, the present invention is directed to a printing apparatus that performs gloss finish treatment on at least a partial region of paper on which an image has been printed, including a gloss finish treatment adding portion that, when subsequently performing gloss finish treatment on the paper, additionally performs gloss finish treatment on a partial region of the paper excluding any gloss-finished region.

In the present invention, when subsequently performing gloss finish treatment on paper, gloss finish treatment is additionally performed on a partial region of the paper excluding any gloss-finished region. Accordingly, gloss finish treatment is not repeatedly performed on the same region of paper, and the image quality does not deteriorate due to gloss finish treatment repeatedly performed on the same region of paper.

Furthermore, in the printing apparatus of the present invention, the gloss finish treatment adding portion may have a storage portion that stores data of the gloss-finished region of the paper and a designation portion that designates a partial region of the paper excluding the gloss-finished region in the data in the storage portion, and may additionally perform gloss finish treatment on the partial region of the paper designated by the designation portion.

When data of a gloss-finished region of the paper is stored in this manner, a partial region of the paper excluding the gloss-finished region can be designated, and gloss finish treatment can be additionally performed on the designated partial region.

Furthermore, in the printing apparatus of the present invention, the gloss finish treatment adding portion may have a display portion that displays an image of the paper such that the gloss-finished region of the paper is displayed in an identifiable manner in the image.

Accordingly, a gloss-finished region of the paper can be easily identified, and the operation for adding a region targeted for gloss finish treatment is effectively aided.

Furthermore, in the printing apparatus of the present invention, the designation portion may be operated to designate a partial region of the paper excluding the gloss-finished region in the image displayed on the display portion.

In this case, it is possible to designate a partial region excluding any gloss-finished region as a region targeted for gloss finish treatment while seeing the gloss-finished region of the paper displayed on the display portion. Thus, the operation for adding a region targeted for gloss finish treatment is effectively aided.

Furthermore, in the printing apparatus of the present invention, it is preferable that the gloss finish treatment adding portion issues a warning in a case where the region of the paper designated by the designation portion overlaps the gloss-finished region of the paper.

In this case, the user can be immediately aware of the state in which a designated region of the paper overlaps a gloss-finished region of the paper, and can immediately correct such an overlap of regions.

Furthermore, in the printing apparatus of the present invention, the gloss finish treatment adding portion may prohibit the designation by the designation portion in a case where the region of the paper designated by the designation portion overlaps the gloss-finished region of the paper.

In this case, any region that overlaps a gloss-finished region of the paper is not designated.

Furthermore, in the printing apparatus of the present invention, the gloss finish treatment adding portion may display a set position and/or a set direction of the paper in the printing apparatus on the display portion.

In order to additionally perform gloss finish treatment on a partial region of the paper excluding any gloss-finished region, it is necessary to prescribe the set position and/or the set direction of the paper in the printing apparatus. Accordingly, the set position and/or the set direction of the paper is displayed.

Furthermore, in the printing apparatus of the present invention, when subsequently performing gloss finish treatment on the paper, the printing apparatus stops image printing on the paper.

When subsequently performing gloss finish treatment on the paper, image printing does not have to be performed on the paper, and, thus, the print processing is stopped.

### BRIEF DESCRIPTION OF DRAWINGS

FIG. 1 is a cross-sectional view showing a printing system according to an embodiment of the present invention.

FIG. 2 is a cross-sectional view showing a coating unit in the printing system in FIG. 1.

FIG. 3 is a cross-sectional view showing a film coating device in the coating unit in FIG. 2.

FIG. 4 is a plan view showing a heater portion in the film coating device in FIG. 3.

FIG. 5 is a cross-sectional view showing an operation state of the film coating device in FIG. 3.

FIG. 6 is a view schematically showing the operation state in FIG. 4.

FIG. 7 is a cross-sectional view showing a coating film.

FIG. 8 is a block diagram showing the configuration of the printing system of this embodiment.

FIG. 9 is a flowchart showing a control procedure for performing resin coating on a recording paper on which a document image has been copied.

FIG. 10 is a view showing a display example on a display device of an image forming apparatus in the printing system of this embodiment.

FIG. 11 is a view showing another display example on the display device of the image forming apparatus in the printing system of this embodiment.

FIG. 12 is a view showing another display example on the display device of the image forming apparatus in the printing system of this embodiment.

FIG. 13 is a view showing another display example on the display device of the image forming apparatus in the printing system of this embodiment.

FIG. 14 is a view showing another display example on the display device of the image forming apparatus in the printing system of this embodiment.

FIG. 15 is a view showing still another display example on the display device of the image forming apparatus in the printing system of this embodiment.

### DESCRIPTION OF PREFERRED EMBODIMENT

Hereinafter, an embodiment of the present invention will be described in detail with reference to the appended drawings.

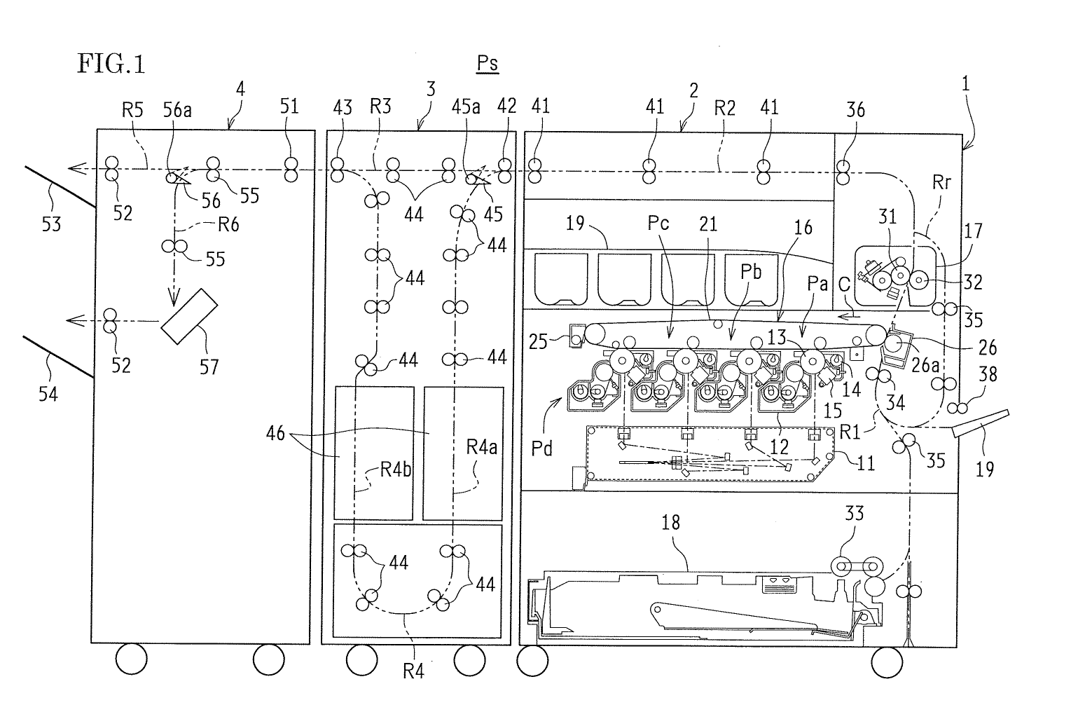

FIG. 1 is a cross-sectional view showing a printing system according to an embodiment of the present invention. In FIG. 1, a printing system Ps is provided with an image forming apparatus 1, a relay unit 2, a coating unit 3, and an aftertreatment unit 4. The image forming apparatus 1 records an image of a document in color or monochrome on recording paper, and transports the recording paper on which the image has been recorded out to the relay unit 2. The relay unit 2 that has received the recording paper from the image forming apparatus 1 relays the recording paper to the coating unit 3. The coating unit 3 that has received the recording paper from the relay unit 2 either transports the recording paper out to the aftertreatment unit 4 without any treatment, or transports the recording paper out to the aftertreatment unit 4 after subjecting the recording paper to resin coating (gloss finish treatment). The aftertreatment unit 4 that has received the recording paper from the coating unit 3 either discharges the recording paper without any treatment, or discharges the recording paper after subjecting the recording paper to aftertreatment such as stapling.

Next, the schematic configurations of the image forming apparatus 1, the relay unit 2, the coating unit 3, and the aftertreatment unit 4 will be described.

Image data processed in the image forming apparatus 1 corresponds to a color image using colors consisting of black (K), cyan (C), magenta (M), and yellow (Y), or corresponds to a monochrome image using a monochrome color (e.g., black). Accordingly, four development devices 12, four photosensitive drums 13, four drum cleaning devices 14, and four charging units 15 are arranged so as to form four types of toner images corresponding to the respective colors. These four constituent elements respectively correspond to black, cyan, magenta, and yellow, and four image stations Pa, Pb, Pc, and Pd are formed.

In the respective image stations Pa, Pb, Pc, and Pd, after the drum cleaning devices 14 remove and recover residual toner on the surfaces of the photosensitive drums 13, the charging units 15 uniformly charge the surfaces of the photosensitive drums 13 to a predetermined potential, an optical scanning device 11 exposes the surfaces of the photosensitive drums 13 to light and forms electrostatic latent images on the surfaces, and the development devices 12 develop the electrostatic latent images on the surfaces of the photosensitive drums 13 and form toner images on the surfaces of the photosensitive drums 13. Accordingly, toner images of the respective colors are formed on the surfaces of the photosensitive drums 13.

Subsequently, while an intermediate transfer belt 21 is circumferentially moving in the arrow direction C, residual toner on the intermediate transfer belt 21 is removed and recovered by a belt cleaning device 25, and, then, the toner images of the respective colors on the surfaces of the photosensitive drums 13 are sequentially transferred and superimposed on the intermediate transfer belt 21, forming a color toner image on the intermediate transfer belt 21.

A nip region is formed between the intermediate transfer belt 21 and a transfer roller 26a of a secondary transfer device 26. While the recording paper that has been transported through a paper transport path R1 is being conveyed through the nip region, the color toner image on the surface of the intermediate transfer belt 21 is transferred to the recording paper. Then, the recording paper is conveyed through a point between a hot roller 31 and a pressure roller 32 of a fixing device 17 for the application of heat and pressure, and, thus, the color toner image on the recording paper is fixed.

Meanwhile, the recording paper is drawn out by a pickup roller 33 from a paper feed tray 18, transported through the S-shaped paper transport path R1 where the recording paper travels via the secondary transfer device 26 and the fixing device 17, and transported out via paper discharge rollers 36 to the relay unit 2. On the paper transport path R1, a pair of registration rollers 34 that, after temporarily stopping the recording paper and aligning the leading edge of the recording paper, start the transport of the recording paper at a timing synchronized with the transfer timing of the color toner image at the nip region between the intermediate transfer belt 21 and the transfer roller 26a, a plurality of pairs of transport rollers 35 that facilitate the transport of the recording paper, the pair of paper discharge rollers 36, and the like are arranged.

Furthermore, when performing printing on both the front face and the back face of the recording paper, the recording paper is transported in the opposite direction from the paper discharge rollers 36 into a reverse path Rr where the front and the back of the recording paper are reversed, and the recording paper is guided again to the registration rollers 34. Subsequently, as in the case of the front face of the recording paper, an image is recorded and fixed to the back face of the recording paper, and the recording paper is transported out to the relay unit 2.

The relay unit 2 is provided with a plurality of pairs of transport rollers 41 that are arranged along a linear relay transport path R2. In the relay unit 2, the recording paper from the image forming apparatus 1 is received, transported along the relay transport path R2, and transported out to the coating unit 3.

The coating unit 3 is provided with a linear through transport path R3, a U-shaped lead-in transport path R4, a pair of transport-in rollers 42 and a pair of transport-out rollers 43 that are arranged at paper inlet and outlet ports of the through transport path R3, a plurality of pairs of transport rollers 44 that are arranged along the through transport path R3 and the lead-in transport path R4, a flapper 45 that is disposed at a branch position between the transport paths R3 and R4, and two film coating devices 46 that are arranged on the lead-in transport path R4.

In the coating unit 3, the transport path of the recording paper differs depending on whether or not resin coating (gloss finish treatment) is to be performed on the recording paper. When not performing resin coating, the flapper 45 is rotationally moved about its shaft 45a to the position indicated by the solid line, so that the recording paper that has been transported in from the relay unit 2 via the transport-in rollers 42 is guided by the flapper 45 and transported into the through transport path R3, and, then, the recording paper is transported out from the through transport path R3 via the transport-out rollers 43 to the aftertreatment unit 4.

On the other hand, when performing resin coating on the recording paper, the flapper 45 is rotationally moved about the shaft 45a to the position indicated by the broken line, so that the recording paper that has been transported in from the relay unit 2 via the transport-in rollers 42 is guided by the flapper 45 and transported into the lead-in transport path R4, and, then, the recording paper is transported out from the lead-in transport path R4 via the transport-out rollers 43 to the aftertreatment unit 4. The U-shaped lead-in transport path R4 includes linear transport path portions R4a and R4b that are parallel to each other, and the linear transport path portions R4a and R4b are respectively provided with the film coating devices 46. At least one of the film coating devices 46 performs resin coating on a partial region or the entire region of the recording paper that is being transported along the transport path portions R4a and R4b. It will be appreciated that it is possible to perform resin coating on a partial region or the entire region of both faces of the recording paper.

The aftertreatment unit 4 is provided with a discharge transport path R5, a stapling transport path R6 that is branched from the discharge transport path R5, a pair of transport-in rollers 51 that are arranged at a paper inlet port of the discharge transport path R5, two pairs of discharge rollers 52 and two paper discharge trays 53 and 54 that are arranged at paper outlet ports of the transport paths R5 and R6, a plurality of pairs of transport rollers 55 that are arranged along the transport paths R5 and R6, a flapper 56 that is disposed at a branch position between the transport paths R5 and R6, and a stapling device 57 that is disposed on the stapling transport path R6.

In the aftertreatment unit 4, the transport path of the recording paper differs depending on whether or not aftertreatment is to be performed on the recording paper. When not performing the aftertreatment, the flapper 56 is rotationally moved about its shaft 56a to the position indicated by the solid line, so that the recording paper that has been transported in from the coating unit 3 via the transport-in rollers 51 is guided by the flapper 56 and transported into the discharge transport path R5, and, then, the recording paper is discharged from the discharge transport path R5 via the discharge rollers 52 to the paper discharge tray 53.

On the other hand, when performing the aftertreatment on the recording paper, the flapper 56 is rotationally moved about the shaft 56a to the position indicated by the broken line, so that the recording paper that has been transported in from the coating unit 3 via the transport-in rollers 51 is guided by the flapper 56 and transported into the stapling transport path R6, and the recording paper is temporarily stacked on the stapling device 57. When such recording papers are stacked to form a bundle on the stapling device 57, the recording paper bundle is stapled, and is then discharged via the discharge rollers 52 to the paper discharge tray 54.

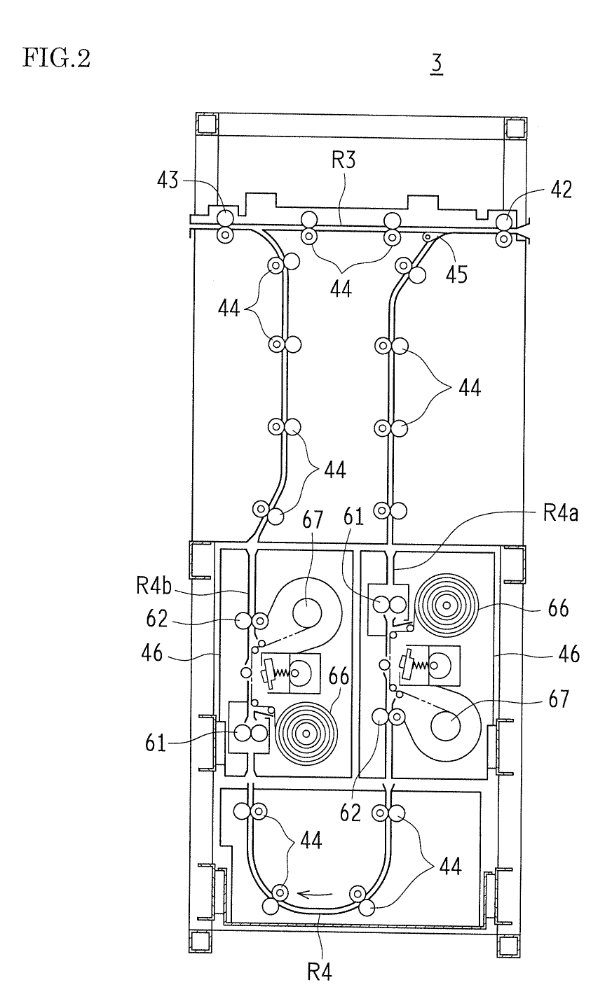

Next, the configuration of the coating unit 3 will be described in more detail. FIG. 2 is a cross-sectional view showing the coating unit 3. As shown in FIG. 2, the coating unit 3 is provided with the linear transport path portions R4a and R4b that are parallel to each other, and the linear transport path portions R4a and R4b are provided with two film coating devices 46 having the same configuration. When the recording paper that has been guided to the lead-in transport path R4 is passing through the linear transport path portion R4a, one of the film coating devices 46 disposed on the transport path portion R4a can perform resin coating (gloss finish treatment) on a partial region or the entire region of one face of the recording paper that is facing the right. When the recording paper has passed through the U-shaped portion of the lead-in transport path R4, the left and the right faces of the recording paper have been reversed. Thus, when the recording paper is passing through the linear transport path portion R4b, the other film coating device 46 disposed on the transport path portion R4b can perform resin coating on a partial region or the entire region of the other face of the recording paper that is facing the right.

Note that, although the film coating devices 46 in the coating unit 3 in FIG. 2 have the same configuration, a recording paper is transported from above to below in one of the film coating devices 46 disposed on the transport path portion R4a, and a recording paper is transported from below to above in the other film coating device 46 disposed on the transport path portion R4b, and, thus, the vertical orientations of the film coating devices 46 are opposite.

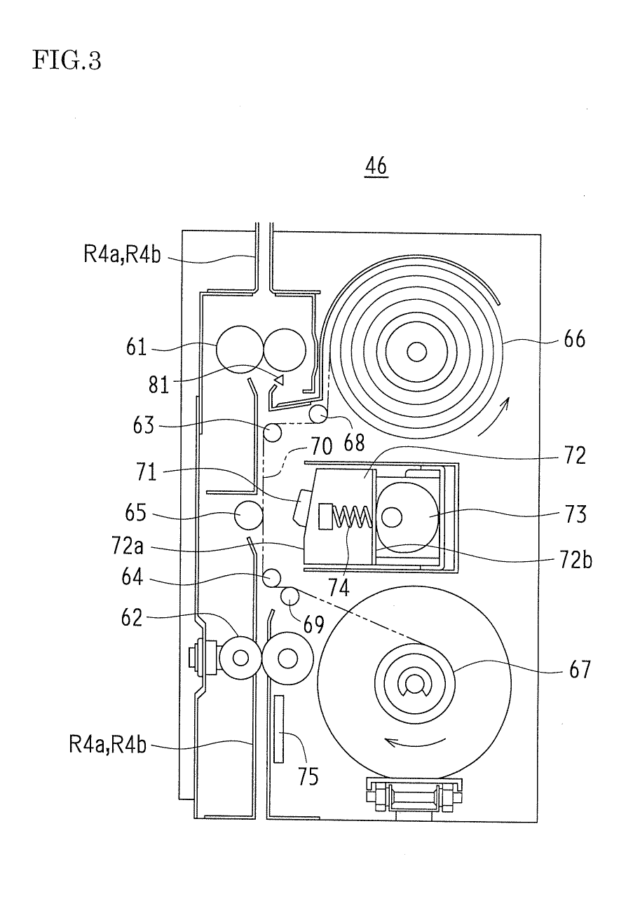

FIG. 3 is a cross-sectional view showing the film coating device 46 of this embodiment. As shown in FIG. 3, the linear transport path portion R4a (R4b) extends inside the film coating device 46, and the film coating device 46 performs resin coating on the recording paper that is being transported through the transport path portion R4a (R4b).

The film coating device 46 is provided with first and second transport rollers 61 and 62, first and second pinch rollers 63 and 64, and a platen roller 65 that are arranged along the transport path portion R4a (R4b), wherein the platen roller 65 is disposed at the center, the first and the second pinch rollers 63 and 64 are arranged on both sides of the platen roller 65, and the pair of first transport rollers 61 and the pair of second transport rollers 62 are arranged on both outer sides of the first and the second pinch rollers 63 and 64. Furthermore, a send-out reel 66 and a take-up reel 67 are arranged along the transport path portion R4a (R4b) so as to be spaced apart therefrom, a first auxiliary roller 68 is disposed between the send-out reel 66 and the first pinch roller 63, and a second auxiliary roller 69 is disposed between the take-up reel 67 and the second pinch roller 64.

The first and the second transport rollers 61 and 62 and the platen roller 65 each have an outer circumference made of synthetic rubber such as EPDM. Furthermore, the first and the second pinch rollers 63 and 64 and the first and the second auxiliary rollers 68 and 69 are each a metal shaft having a diameter of approximately 8 mm.

A coating film 70 is wrapped around the send-out reel 66 in advance. The coating film 70 is drawn out from the send-out reel 66, caught on the first auxiliary roller 68 and the first pinch roller 63, guided via the transport path portion R4a (R4b) to the second pinch roller 64, caught on the second pinch roller 64 and the second auxiliary roller 69, and drawn around the take-up reel 67, and an end of the coating film 70 is connected to the take-up reel 67. Between the first and the second pinch rollers 63 and 64, the coating film 70 is stretched in the shape of a straight line through the transport path portion R4a (R4b).

The take-up reel 67 is rotationally driven clockwise by a motor (not shown) dedicated to the take-up reel, and takes up the coating film 70. Furthermore, the send-out reel 66 sends out the coating film 70 and rotates as the take-up reel 67 takes up the coating film 70, or, as described later, sends out the coating film 70 and rotates counterclockwise as the recording paper P that has been overlaid on the coating film 70 is transported. Accordingly, the coating film 70 is transported through the transport path portion R4a (R4b) between the first and the second pinch rollers 63 and 64. The speed at which the coating film 70 is transported as being taken up by the take-up reel 67 is set to be equal to or lower than the recording paper transport speed (325 mm/sec).

Furthermore, torque limiters (not shown) are respectively provided on the shaft of the send-out reel 66 and the shaft of the take-up reel 67, so that, when an excessive load is imposed on the reels 66 and 67 and the coating film 70 as the coating film 70 is taken up or sent out, the respective torque limiters cause the reels 66 and 67 to idly rotate.

Furthermore, the first transport rollers 61, the second transport rollers 62, and the platen roller 65 are rotationally driven by respective dedicated motors, and rotate at respective circumferential speeds corresponding to the recording paper transport speed.

Furthermore, a thermal head 71 is disposed between the reels 66 and 67, and the thermal head 71 and the platen roller 65 oppose each other. The thermal head 71 is fixed to the left side face of a movable member 72 that is supported such that it can move in horizontal directions, and horizontally moves together with the movable member 72. A spring 74 has a left end that is fixed to a position and a right end that is connected to the movable member 72, and biases the movable member 72 rightward. A circumferential face of an eccentric cam 73 is in contact with the right side face of the movable member 72 that is biased rightward by the spring 74. The eccentric cam 73 is rotationally driven by a motor (not shown) dedicated to the eccentric cam, and the movable member 72 and the thermal head 71 are horizontally moved and positioned as the eccentric cam 73 rotates.

Furthermore, a heater portion 75 is provided at a position spaced apart by approximately 60 to 80 mm from the second transport rollers 62 on the downstream side in the recording paper transport direction. The heater portion 75 is disposed so as to be slightly spaced apart from the recording paper that is being transported through the transport path portion R4a (R4b), and is not in contact with the recording paper. The heater portion 75 radiates heat toward the recording paper.

Furthermore, a sensor 81 that detects the leading edge of the recording paper that is being transported through the transport path portion R4a (R4b) is provided between the first transport rollers 61 and the first pinch roller 63.

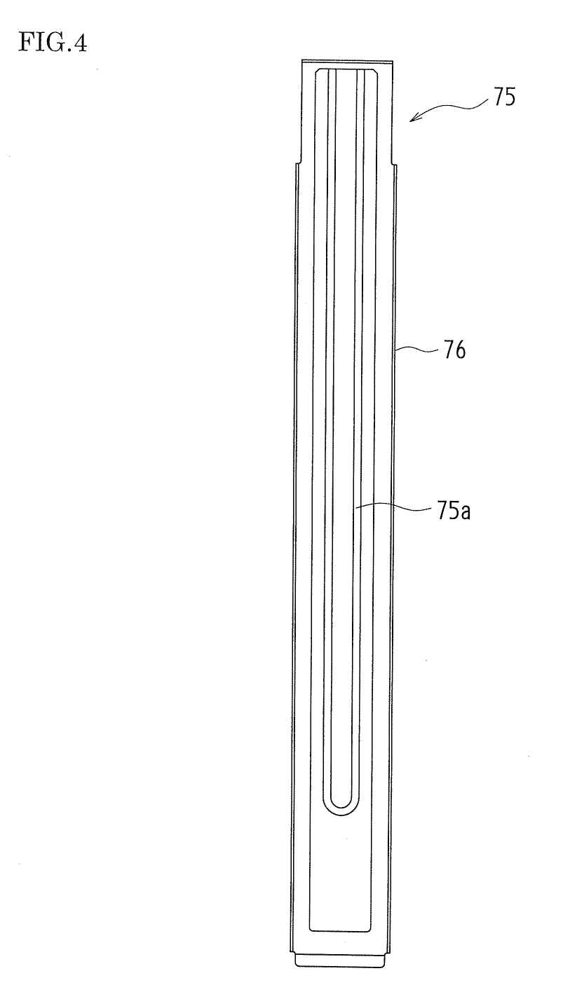

FIG. 4 is a plan view showing the heater portion 75. As shown in FIG. 4, a U-shaped heater 75a is fixedly supported on a frame 76. The U-shaped heater 75a is configured by a nichrome wire, a lamp, or the like, and heat is radiated from the U-shaped heater 75a toward the recording paper.

In the coating unit 3, when not performing resin coating on the recording paper, the recording paper is transported through the through transport path R3. In this case, in each of the film coating devices 46, the reels 66 and 67 are stopped, so that the coating film 70 is not sent out or taken up, and the first transport rollers 61, the second transport rollers 62, and the platen roller 65 are also stopped. Furthermore, the eccentric cam 73 is rotated, so that the movable member 72 and the thermal head 71 are moved rightward, and the thermal head 71 is moved away from the platen roller 65. Moreover, the thermal head 71 and the heater portion 75 are not caused to generate heat.

On the other hand, in the coating unit 3, when performing resin coating on the recording paper, the recording paper is guided to the lead-in transport path R4 where the recording paper is transported in order of the linear transport path portion R4a→the U-shaped portion of the lead-in transport path R4→the linear transport path portion R4b, and at least one of the film coating devices 46 is caused to perform resin coating on a partial region or the entire region of the recording paper that is being transported. At that time, in the film coating devices 46, the first transport rollers 61, the second transport rollers 62, and the platen rollers 65 are rotated, so that the recording paper transport operation is started.

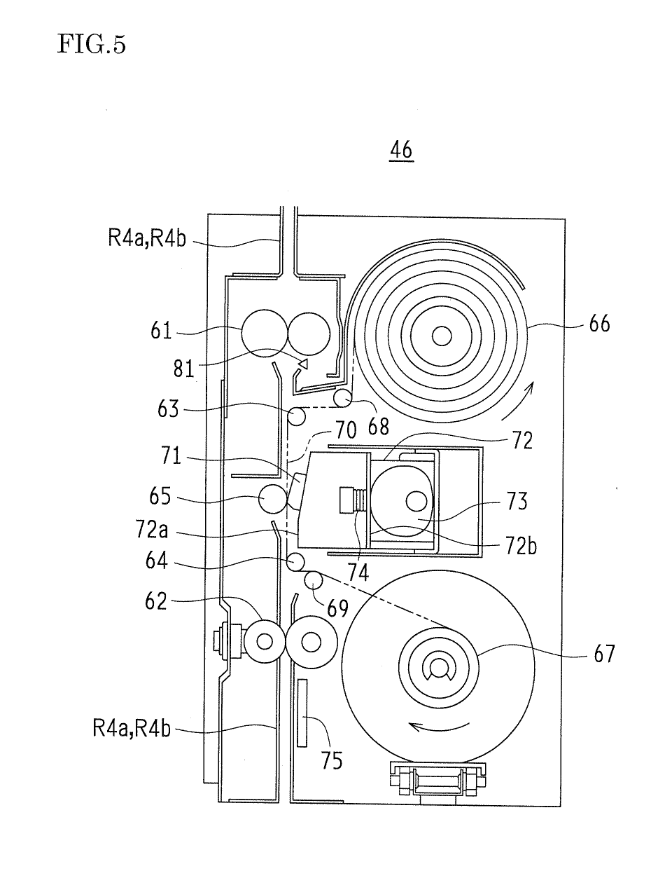

Furthermore, in at least one of the film coating devices 46 that performs resin coating, not only is the recording paper transport operation started, but the take-up reel 67 is rotated, so that the coating film 70 is transported through the transport path portions R4a and/or R4b, and the speed at which the coating film 70 is transported as being taken up by the take-up reel 67 is set to be equal to or lower than the recording paper transport speed. Furthermore, as shown in FIG. 5, the eccentric cam 73 is rotated, so that the movable member 72 and the thermal head 71 are moved leftward, and the thermal head 71 is pressed against the platen roller 65 via the coating film 70. Furthermore, the thermal head 71 is caused to generate heat at a prescribed temperature (e.g., 100 to 150° C.), and the heater portion 75 is caused to generate heat at another prescribed temperature (e.g., 40 to 80° C.).

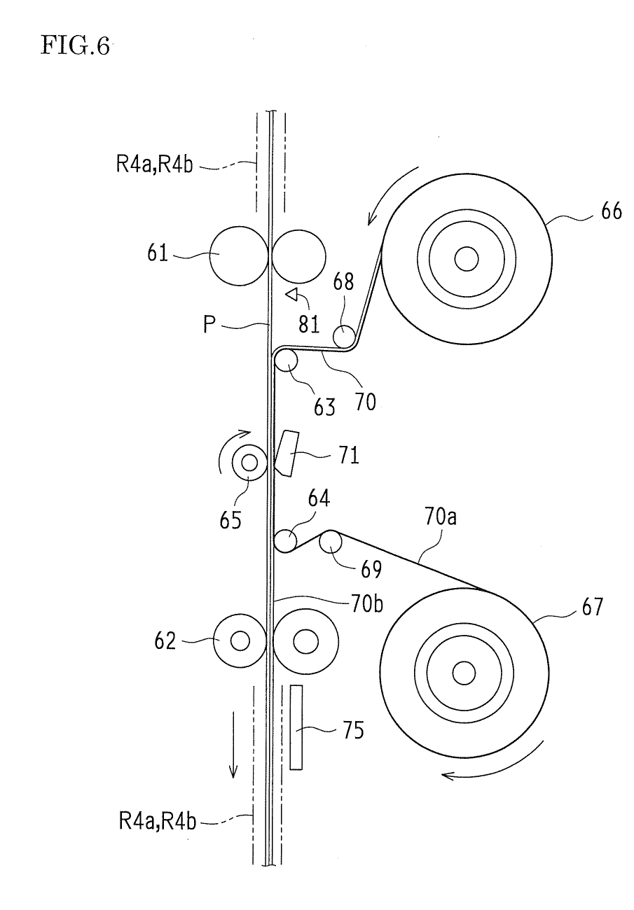

FIG. 6 schematically shows the operation state in FIG. 5. As shown in FIG. 6, when the recording paper P is transported to the transport path portion R4a (R4b), the recording paper P is transported by the first transport rollers 61, and is then overlaid on the coating film 70 at the position of the first pinch roller 63, and the recording paper P and the coating film 70 are transported and guided to a point between the thermal head 71 and the platen roller 65. Furthermore, the coating film 70 is sent out from the send-out reel 66, and the send-out reel 66 idly rotates. While the recording paper P and the coating film 70 are being transported by the platen roller 65, the recording paper P and the coating film 70 are pressed by the thermal head 71 and the platen roller 65, the coating film 70 is brought into sliding contact with heat generating members on the lower face of the thermal head 71, and the coating film 70 is heated. Accordingly, the coating resin layer of the coating film 70 is brought into close contact with one face of the recording paper P.

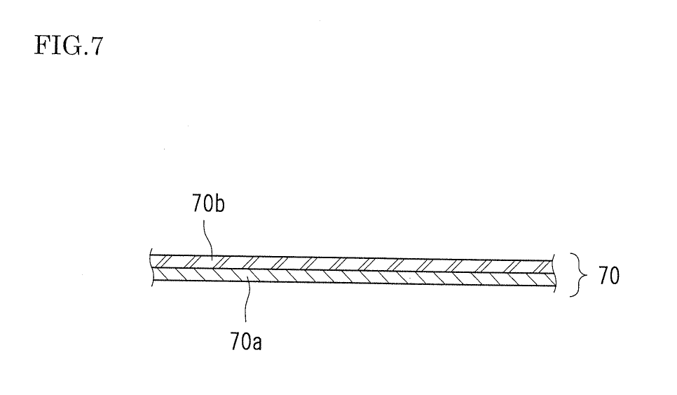

FIG. 7 is a cross-sectional view showing the coating film 70. As shown in FIG. 7, the coating film 70 includes a film base 70a that is made of polyethylene terephthalate (PET) or the like and a coating resin layer 70b that is made of styrene or the like and is layered on the film base 70a. The coating film 70 has a thickness of 3 to 6μ. In the film coating device 46, the coating resin layer 70b of the coating film 70 is overlaid on the recording paper P, and melted by the application of heat from the thermal head 71, thereby being brought into close contact with the recording paper P.

Furthermore, the thermal head 71 has heat generating members that are arranged in a direction (main-scanning direction) orthogonal to the recording paper transport direction (sub-scanning direction). The coating resin layer 70b can be brought into close contact with a partial region or the entire region of the recording paper, by selectively causing the heat generating members to generate heat, and setting the heat generation start timing and the heat generation end timing of the heat generating members. A region in the main-scanning direction of the recording paper with which the coating resin layer 70b is to be brought into close contact can be set by selecting the heat generating members of the thermal head 71. Furthermore, a region in the sub-scanning direction of the recording paper with which the coating resin layer 70b is to be brought into close contact can be set by setting the heat generation start timing and the heat generation end timing of the selected heat generating members. Accordingly, the coating resin layer 70b can be brought into close contact with a partial region or the entire region of the recording paper.

Subsequently, the recording paper P and the coating film 70 that have been overlaid on each other and brought into close contact with each other as shown in FIG. 6 are transported to the second pinch roller 64. Then, the film base 70a of the coating film 70 is drawn by the second pinch roller 64 onto the second auxiliary roller 69, separated obliquely from the transport path portion R4a (R4b), and taken up by the take-up reel 67. Furthermore, the coating resin layer 70b is separated from the film base 70a at the position of the second pinch roller 64, and the recording paper P and the coating resin layer 70b are transported to the second transport rollers 62. At the time of this separation, the coating resin layer 70b is cut along the peripheral edge of a range in which the coating resin layer 70b has been brought into close contact with the recording paper P (e.g., the same range as the recording paper P), and resin coating on a partial region or the entire region of the recording paper is completed.

After the coating resin layer 70b is separated from the film base 70a and resin coating on the recording paper is completed in this manner, the recording paper P is transported via the second transport rollers 62, and passes through a point near the heater portion 75. At that time, due to heat radiation from the heater portion 75, the surface of the coating resin layer 70b that has been brought into close contact with the recording paper is temporarily melted by the application of heat, and becomes smooth. The temperature of the heater portion 75 is set to a prescribed temperature (e.g., 40 to 80° C.) at which the surface of the coating resin layer 70b is melted by the application of heat but the coating resin layer 70b is not completely melted by the application of heat so does not penetrate into the recording paper. Accordingly, marks on the surface of the coating resin layer 70b caused by separation or by contact with the second transport rollers 62 can be erased, and the transparency of the coating resin layer 70b is improved.

In this manner, in the printing system Ps, the image forming apparatus 1 can form an image by printing on the recording paper, continuously after which the coating unit 3 can perform resin coating (gloss finish treatment) on a partial region or the entire region of the recording paper by causing the coating resin layer 70b to be brought into close contact with the partial region or the entire region of the recording paper. For example, it is possible to perform resin coating only on a photograph region printed on the recording paper.

However, when performing resin coating only on a partial region of the recording paper, it may be necessary to add another region targeted for resin coating. For example, in the case where, after a photograph region printed on the recording paper has been selected and subjected to resin coating, resin coating on a logo region printed on the recording paper is required to be added, this logo region has to be subjected to resin coating. Note that, if resin coating is repeatedly performed on the same portion of the recording paper due to erroneous operations or designations, the image quality of this portion significantly deteriorates.

Thus, in this embodiment, when subsequently performing resin coating on the recording paper, resin coating is additionally performed on a partial region of the recording paper excluding the resin-coated region. Accordingly, resin coating is not repeatedly performed on the same region of the recording paper, and the image quality does not deteriorate.

Next, the configuration and the processing for additionally performing resin coating on a partial region of a recording paper excluding any resin-coated region will be described.

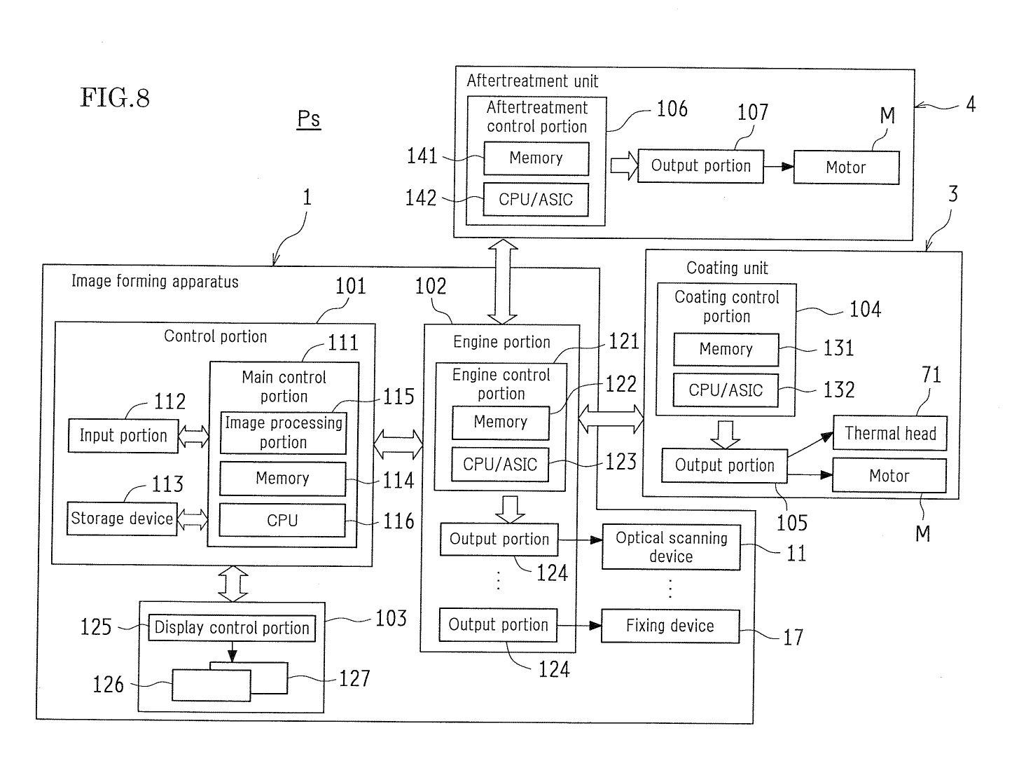

FIG. 8 is a block diagram showing the configuration of the printing system Ps of this embodiment. As shown in FIG. 8, the image forming apparatus 1 is provided with a control portion 101, an engine portion 102, an operation panel 103, and the like. Furthermore, the coating unit 3 is provided with a coating control portion 104, an output portion 105, and the like, and the aftertreatment unit 4 is provided with an aftertreatment control portion 106, an output portion 107, and the like.

In the image forming apparatus 1, the control portion 101 is provided with a main control portion 111, an input portion 112, a storage device 113 that stores image data, and the like. The main control portion 111 is provided with a memory 114 that stores image data, programs, and the like, an image processing portion 115 that processes image data, a CPU 116 that executes programs, thereby comprehensively controlling the printing system Ps, and the like. The input portion 112 is configured by a scanner that reads a document image, generates image data indicating the document image, and outputs the image data, an interface that receives and inputs image data from the outside, and the like.

The engine portion 102 is provided with an engine control portion 121, a plurality of output portions 124, and the like. The engine control portion 121 is provided with a memory 122 that stores programs and the like, and a CPU (or ASIC) 123 that executes programs in response to an instruction from the main control portion 111, thereby, via the output portions 124, controlling the driving of the optical scanning device 11, the fixing device 17, and the like of the image forming apparatus 1, and controlling the driving of the motors of the rollers that are arranged along the paper transport path R1 or the relay transport path R2 of the relay unit 2.

The operation panel 103 has a display control portion 125, a crystal display device 126, a touch panel 127 that is superimposed on a screen of the crystal display device 126, a plurality of operation keys (not shown), and the like. The operation keys are operated for inputting instructions and the like to the image forming apparatus 1. Furthermore, the screen of the crystal display device 126 displays operation guidance, touch keys, and the like of the image forming apparatus 1, and the touch panel 127 detects an operation on the touch keys.

In the coating unit 3, the coating control portion 104 is provided with a memory 131 that stores programs and the like, and a CPU (or ASIC) 132 that executes programs in response to an instruction from the main control portion 111, thereby, via the output portion 105, controlling the driving of the motors of the take-up reels 67, the motors M of the platen rollers 65, and the thermal heads 71 of the film coating devices 46, and the motors M of the rollers and the flapper 45 that are arranged along the through transport path R3 and the lead-in transport path R4.

Furthermore, in the aftertreatment unit 4, the aftertreatment control portion 106 is provided with a memory 141 that stores programs and the like, and a CPU (or ASIC) 142 that executes programs in response to an instruction from the main control portion 111, thereby, via the output portion 107, controlling the driving of the motor M of the stapling device 57 and the motors M of the rollers and the flapper 56 that are arranged along the discharge transport path R5 and the stapling transport path R6.

In this sort of configuration, when an instruction to copy a document image is given through an operation on the operation panel 103, in response to this instruction, the main control portion 111 performs control so that the document image is read by the input portion (scanner) 112 and image data indicating the document image is output from the input portion 112. This image data is processed by the image processing portion 115, and output via the engine control portion 121 and the output portions 124 to the optical scanning device 11. Furthermore, the engine control portion 121 executes programs in response to an instruction from the main control portion 111, thereby, via the output portions 124, controlling the driving of the optical scanning device 11, the fixing device 17, and the like, or controlling the driving of the motors of the rollers that are arranged along the paper transport path R1 and the relay transport path R2 of the relay unit 2. Accordingly, in the image forming apparatus 1, a document image is copied on the recording paper, and this recording paper is transported from the image forming apparatus 1 via the relay unit 2 to the coating unit 3.

Furthermore, the main control portion 111 controls the coating unit 3 via the engine control portion 121. The control of the coating unit 3 by the main control portion 111 differs depending on whether the recording paper is to be transported out to the aftertreatment unit 4 without any treatment, or to be transported out to the aftertreatment unit 4 after subjecting the recording paper to resin coating (gloss finish treatment). In the former case, the main control portion 111 gives the coating control portion 104 an instruction to keep the film coating devices 46 in a stopped state. In response to this instruction, the coating control portion 104 keeps the film coating devices 46 in a stopped state, and controls via the output portion 105 the driving of the motors of the rollers and the flapper 45 that are arranged along the through transport path R3, so that the recording paper is transported out via the through transport path R3 to the aftertreatment unit 4. Furthermore, in the latter case, the main control portion 111 gives the coating control portion 104 an instruction to start the operation of the film coating devices 46. In response to this instruction, the coating control portion 104 controls via the output portion 105 the driving of the motors of the rollers and the flapper 45 that are arranged along the through transport path R3 and the lead-in transport path R4, so that the recording paper is guided and transported to the lead-in transport path R4. Furthermore, the coating control portion 104 performs control via the output portion 105 so that the first transport rollers 61, the second transport rollers 62, and the platen rollers 65 in the film coating devices 46 are rotated to start the recording paper transport operation. Furthermore, the coating control portion 104 performs control of at least one of the film coating devices 46 via the output portion 105 so as to press the thermal head 71 against the platen roller 65 and to generate heat from the heater portion 75. Accordingly, at least one of the film coating devices 46 performs resin coating on a partial region or the entire region of the recording paper that is being transported along the transport path portion R4a (R4b), and, then, the recording paper is transported out to the aftertreatment unit 4.

Furthermore, the main control portion 111 controls the aftertreatment unit 4 via the engine control portion 121. The control of the aftertreatment unit 4 by the main control portion 111 differs depending on whether the recording paper is to be or not to be subjected to the aftertreatment. In the former case, the main control portion 111 gives the aftertreatment control portion 106 an instruction to keep the stapling device 57 in a stopped state. In response to this instruction, the aftertreatment control portion 106 keeps the stapling device 57 in a stopped state, and controls via the output portion 107 the driving of the motors of the rollers and the flapper 56 that are arranged along the discharge transport path R5, so that the recording paper is discharged via the discharge transport path R5 to the paper discharge tray 53. Furthermore, in the latter case, the main control portion 111 gives the aftertreatment control portion 106 an instruction to start the operation of the stapling device 57. In response to this instruction, via the output portion 107, the aftertreatment control portion 106 controls the driving of the motor of the stapling device 57 and the like, and controls the driving of the motors of the rollers and the flapper 56 that are arranged along the discharge transport path R5 and the stapling transport path R6, so that the recording papers are guided to the stapling transport path R6, temporarily stacked on the stapling device 57, and stapled by the stapling device 57 into a recording paper bundle, and the recording paper bundle is discharged to the paper discharge tray 54.

Next, a control procedure for performing resin coating on the recording paper will be described in detail. In this example, the case where a document image is copied on the recording paper by the image forming apparatus 1, continuously after which resin coating is performed by the coating unit 3 on a partial region or the entire region in the document image that has been copied on the recording paper, and the case where the recording paper on which a document image has been copied is set again in the image forming apparatus 1, and resin coating is performed or added on the document image on the recording paper will be separately described.

First, in the former case, for example, the operation panel 103 is operated to give an instruction to copy a document image, and, at the same, to give an instruction to perform resin coating on a photograph region or the like, without giving an instruction to perform aftertreatment. In response to these instructions, a document image is read by the input portion (scanner) 112, and image data indicating the document image is input from the input portion 112 to the image processing portion 115. The image processing portion 115 performs various types of image processing on the image data, and, furthermore, extracts a photograph region in the document image based on the image data, obtains the position (the position in the main-scanning direction and the position in the sub-scanning direction) of the photograph region in the document image, and stores the image data indicating the document image and the position of the photograph region in the storage device 113. Then, the main control portion 111 outputs, to the engine control portion 121, an instruction to copy the document image and the image data indicating the document image. Furthermore, the main control portion 111 gives the coating control portion 104 an instruction to start the operation and the position of the photograph region in the document image via the engine control portion 121. Furthermore, the main control portion 111 gives the aftertreatment control portion 106 an instruction to keep the stapling device 57 in a stopped state via the engine control portion 121.

The engine control portion 121 to which the instruction to copy the document image and the image data indicating the document image have been input controls the driving of the optical scanning device 11, the fixing device 17, and the like, and controls the driving of the motors of the rollers that are arranged along the paper transport path R1 and the relay transport path R2 of the relay unit 2, via the output portions 124. Accordingly, in the image forming apparatus 1, a document image is copied on the recording paper, and this recording paper is transported from the image forming apparatus 1 via the relay unit 2 to the coating unit 3.

Furthermore, since the coating control portion 104 of the coating unit 3 has received the instruction to start the operation and the position (the position in the main-scanning direction and the position in the sub-scanning direction) of the photograph region in the document image from the main control portion 111, the coating control portion 104 controls via the output portion 105 the driving of the motors of the rollers and the flapper 45 that are arranged along the through transport path R3 and the lead-in transport path R4, so that the recording paper is guided and transported to the lead-in transport path R4. Furthermore, the coating control portion 104 starts the operation of the film coating devices 46 via the output portion 105. In this example, it is assumed that a document image is copied on one of the two faces of the recording paper, and a photograph region of the one face of the recording paper is subjected to resin coating. Accordingly, the coating control portion 104 performs control in one film coating device (hereinafter, it may be referred to as a “first film coating device”) 46 that is disposed on the transport path portion R4a so as to press the thermal head 71 against the platen roller 65 and to generate heat from the heater portion 75, while performing control in the other film coating device (hereinafter, it may be referred to as a “second film coating device”) 46 that is disposed on the transport path portion R4b so as to keep the thermal head 71 away from the platen roller 65 and not to generate heat from the heater portion 75. Furthermore, in the film coating devices 46, the first transport rollers 61, the second transport rollers 62, and the platen rollers 65 are rotated, so that the recording paper can be transported.

When the recording paper that is being transported reaches the first film coating device 46 that is disposed on the transport path portion R4a, the sensor 81 detects the leading edge of the recording paper. The detection output of the sensor 81 is input to the coating control portion 104, and, when the sensor 81 detects the leading edge of the recording paper, the coating control portion 104 controls the driving of the motor of the take-up reel 67, so that the coating film 70 is moved through the transport path portion R4a, and the moving speed of the coating film 70 is set to match the recording paper transport speed.

Furthermore, the coating control portion 104 obtains the sliding contact start timing and the sliding contact end timing of the photograph region in the document image that has been copied on the recording paper with respect to the heat generating members of the thermal head 71, based on the timing at which the sensor 81 detects the leading edge of the recording paper and the position in the sub-scanning direction of the photograph region in the document image instructed by the main control portion 111, and selectively obtains the heat generating members of the thermal head 71 that overlap the photograph region in the document image that has been copied on the recording paper, based on the position in the main-scanning direction of the photograph region in the document image instructed by the main control portion 111. Then, the coating control portion 104 causes only the selected heat generating members of the thermal head 71 to generate heat only in the period from the sliding contact start timing to the sliding contact end timing. Accordingly, when the photograph region in the document image that has been copied on the recording paper is passing through a point between the thermal head 71 and the platen roller 65, the coating resin layer of the coating film 70 is brought into close contact only with the photograph region in the recording paper, and only the photograph region in the recording paper is subjected to resin coating.

In the case where the original document image and the recording paper have the same size, and the position of the photograph region in the original document image matches the position of the photograph region in the recording paper, this position of the photograph region in the original document image is used to selectively obtain the sliding contact start timing and the sliding contact end timing of the photograph region with respect to the heat generating members of the thermal head 71, and the heat generating members of the thermal head 71 that overlap the photograph region. Furthermore, in the case where the original document image is copied on the recording paper by the image forming apparatus 1 after magnification or reduction, the position of the photograph region in the recording paper is obtained based on the position of the photograph region in the original document image and the ratio of the document image magnified or reduced, and this position of the photograph region in the recording paper is used to selectively obtain the sliding contact start timing and the sliding contact end timing of the photograph region with respect to the heat generating members of the thermal head 71, and the heat generating members of the thermal head 71 that overlap the photograph region.

The recording paper on which resin coating has been performed in this manner is transported from the coating unit 3 to the aftertreatment unit 4.

Since the aftertreatment control portion 106 of the aftertreatment unit 4 has received the instruction to keep the stapling device 57 in a stopped state from the main control portion 111, the aftertreatment control portion 106 keeps the stapling device 57 in a stopped state, and controls via the output portion 107 the driving of the motors of the rollers and the flapper 56 that are arranged along the discharge transport path R5, so that the recording paper is discharged via the discharge transport path R5 to the paper discharge tray 53.

In this manner, the image is copied on the recording paper by the image forming apparatus 1, continuously after which only the photograph region in the recording paper is subjected to resin coating by the coating unit 3.

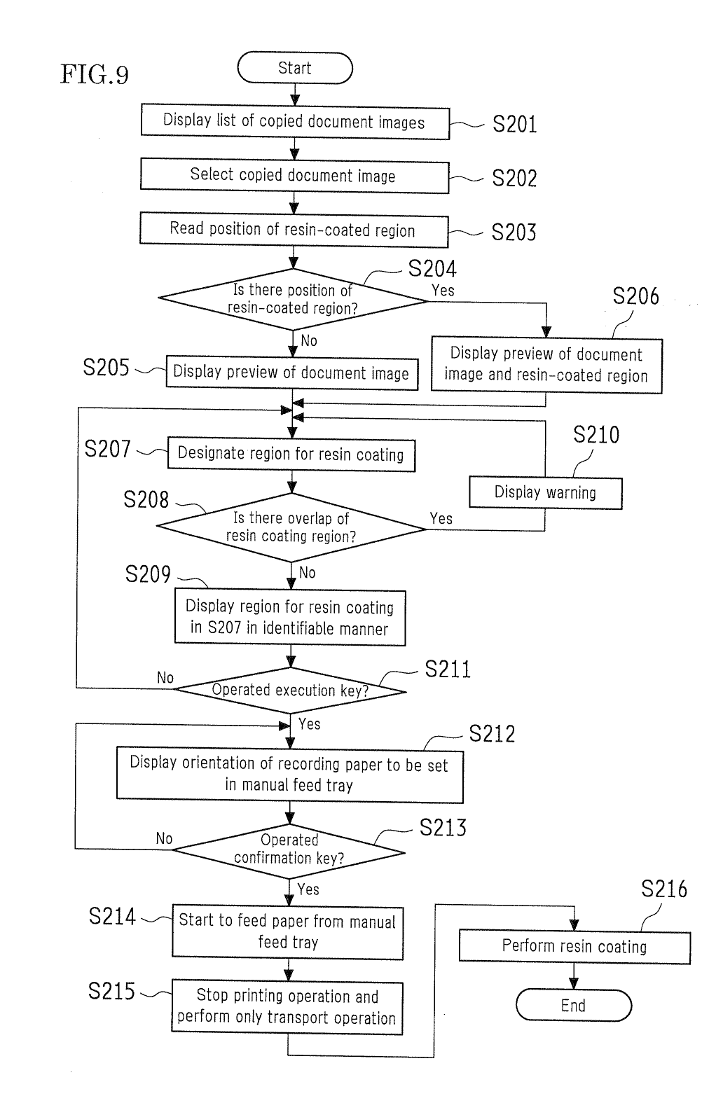

Next, a control procedure for setting again the recording paper on which the document image has been copied in the image forming apparatus 1, and performing or adding resin coating on the document image on the recording paper will be described with reference to the flowchart shown in FIG. 9. In this example, it is assumed that resin coating is performed on a logo region in the document image that has been copied on the recording paper.

First, the operation panel 103 is operated to give an instruction to issue a resin coating request on the recording paper on which the document image has been copied. In response to this instruction, the main control portion 111 reads image data indicating copied document images from the storage device 113, creates a list of the copied document images, and outputs the list of the copied document images to the display control portion 125 of the operation panel 103. The display control portion 125 to which the list of the copied document images has been input displays the list of the copied document images on the screen of the crystal display device 126 (step S201). For example, a list of the copied document images as thumbnails is created and displayed on the screen of the crystal display device 126.

In this state, when any copied document image is selected on the screen of the crystal display device 126, the display control portion 125 determines the selected copied document image through the touch panel 127 of the operation panel 103, and notifies the main control portion 111 of this determination result. In response to this notification, the main control portion 111 reads image data indicating the selected copied document image from the storage device 113, and outputs the image data to the display control portion 125 of the operation panel 103 (step S202). Furthermore, if, as well as the image data indicating the selected copied document image, the position of a photograph region (resin-coated region) in the document image is stored in the storage device 113, the main control portion 111 reads the position of the photograph region from the storage device 113, and outputs the position of the photograph region to the display control portion 125 of the operation panel 103 (step S203).

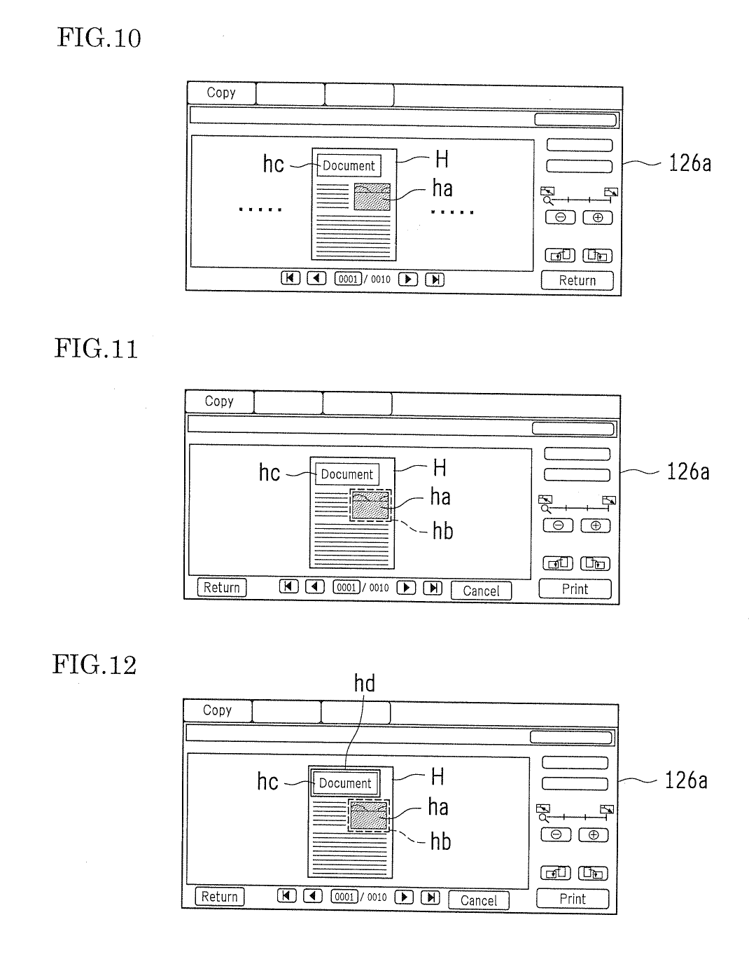

On the other hand, if only the image data indicating the copied document image is input to the display control portion 125 (“No” in step S204), the copied document image is displayed on the screen of the crystal display device 126 (step S205). For example, as shown in FIG. 10, a document image H is displayed on a screen 126a of the crystal display device 126.

Furthermore, if the image data indicating the copied document image and the position of the photograph region (resin-coated region) are input to the display control portion 125, the copied document image is displayed on the screen of the crystal display device 126, and the photograph region is displayed in an identifiable manner in the document image on the screen (step S206). For example, as shown in FIG. 11, the document image H is displayed on the screen 126a of the crystal display device 126, and a broken line hb that defines a photograph region ha on the document image H is displayed so that the photograph region ha is displayed in an identifiable manner.

In the state where the document image is displayed on the screen of the crystal display device 126 in this manner, a region in which resin coating is to be performed or added is designated in the document image. For example, diagonal vertices of a rectangular region in which resin coating is to be performed or added are designated in the document image on the screen of the crystal display device 126 (step S207). The display control portion 125 determines the positions of the diagonal vertices of the rectangular region through the touch panel 127, obtains the position (the position in the main-scanning direction and the position in the sub-scanning direction) of the rectangular region based on the positions of the diagonal vertices, and notifies the main control portion 111 of the position of the rectangular region.

If there is no photograph region in the copied document image (e.g., the document image H in FIG. 10), the main control portion 111 determines that there is no overlap of regions (“No” in step S208), and causes the display control portion 125 to display the rectangular region designated in step S207 in an identifiable manner on the screen of the crystal display device 126 (step S209).

On the other hand, if there is a photograph region in the copied document image (e.g., the document image H in FIG. 11), the main control portion 111 compares the position of the rectangular region designated in step S207 and the position of the photograph region (resin-coated region) previously read from the storage device 113, and determines whether or not their regions overlap each other (step S208). If their regions overlap each other (“Yes” in step S208), the main control portion 111 causes the display control portion 125 to display a warning to the effect that resin coating cannot be performed, on the screen of the crystal display device 126 (step S210). Then, the procedure returns to step S207, and a standby state is maintained until a rectangular region in which resin coating is to be performed or added is designated again. The reason for this is that, if resin coating is performed on the rectangular region designated in step S207, resin coating is performed twice on at least part of the photograph region that overlaps this rectangular region, and the image quality of this part significantly deteriorates.

Furthermore, if their regions do not overlap each other (“No” in step S208), the main control portion 111 causes the display control portion 125 to display the rectangular region designated in step S207 in an identifiable manner on the screen of the crystal display device 126 (step S209). For example, as shown in FIG. 12, the document image H is displayed on the screen 126a of the crystal display device 126, and a line hd that defines a logo region hc on the document image H is displayed so that the logo region hc is displayed in an identifiable manner.

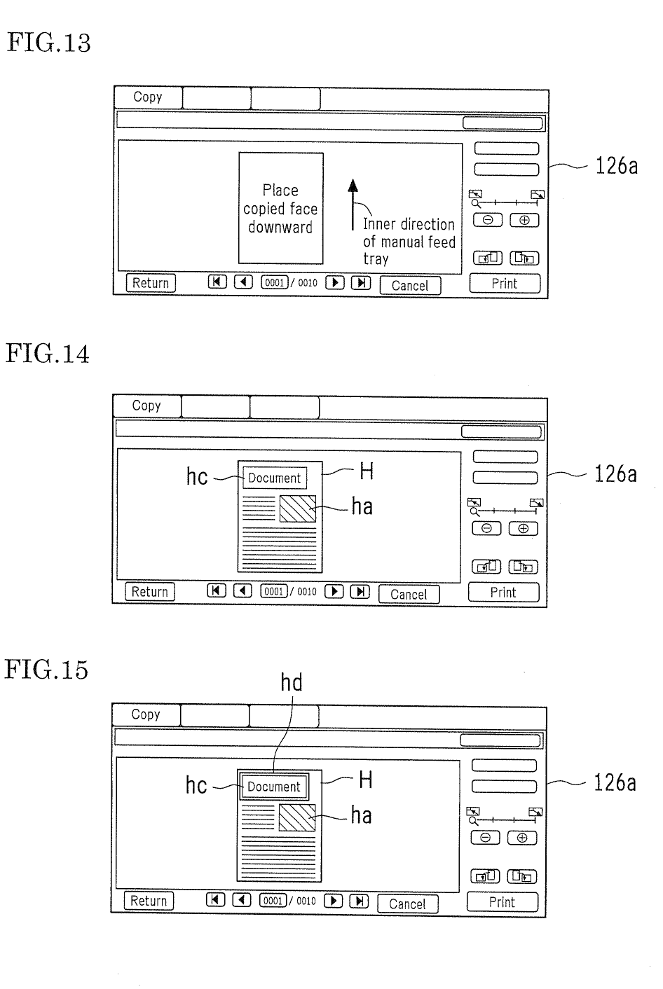

After the logo region is designated in this manner, an execution key (not shown) of the operation panel 103 is operated (step S211). In response to this operation, the main control portion 111 displays a direction in which the recording paper is to be placed on a manual feed tray 19 as shown in FIG. 13 (step S212). The reason for this is that, if whether the document image that has been copied on the recording paper is to be oriented face up or face down on the manual feed tray 19 is designated, one film coating device 46 that can perform resin coating on the document image on the recording paper can be specified, and, if the direction in which the recording paper is to be placed on the manual feed tray 19 is designated, the execution timing for the film coating device 46 to perform resin coating on the logo region in the recording paper can be specified. In this example, a message is displayed to the effect that the copied face of the recording paper is to be oriented face down, and that the upper edge of the document image that has been copied on the recording paper is to be oriented inward in the manual feed tray 19.

Following this display in FIG. 13, the recording paper is placed on the manual feed tray 19 such that the copied face of the recording paper is oriented face down, and such that the upper edge of the document image that has been copied on the recording paper is oriented inward in the manual feed tray 19. Then, a confirmation key (not shown) of the operation panel 103 is operated to give an instruction to start resin coating on the recording paper (step S213). In response to this instruction, the main control portion 111 outputs, to the engine control portion 121, an instruction to stop the printing operation and an instruction to transport the recording paper. Furthermore, the main control portion 111 gives the coating control portion 104 an instruction to start the operation and the position (the position in the main-scanning direction and the position in the sub-scanning direction) of the logo region in the document image via the engine control portion 121. Furthermore, the main control portion 111 gives the aftertreatment control portion 106 an instruction to keep the stapling device 57 in a stopped state via the engine control portion 121.

The engine control portion 121 to which the instruction to stop the printing operation and the instruction to transport the recording paper have been input sets the optical scanning device 11, the fixing device 17, and the like to a stopped state, and controls the driving of the motors of the rollers that are arranged along the paper transport path R1 and the relay transport path R2 of the relay unit 2, via the output portions 124. Accordingly, the copied recording paper is drawn out from the manual feed tray 19 (step S214), and this recording paper is transported from the image forming apparatus 1 via the relay unit 2 to the coating unit 3 without being subjected to image printing (step S215).

At that time, since the coating control portion 104 of the coating unit 3 has received the instruction to start the operation and the position (the position in the main-scanning direction and the position in the sub-scanning direction) of the logo region in the document image from the main control portion 111, the coating control portion 104 controls via the output portion 105 the driving of the motors of the rollers and the flapper 45 that are arranged along the through transport path R3 and the lead-in transport path R4, so that the recording paper is guided and transported to the lead-in transport path R4. Furthermore, the coating control portion 104 starts the operation of the film coating devices 46 via the output portion 105. In this example, resin coating is performed on the logo region of one of the two faces of the recording paper, and, thus, the coating control portion 104 performs control in the first film coating device 46 that is disposed on the transport path portion R4a so as to press the thermal head 71 against the platen roller 65 and to generate heat from the heater portion 75, while performing control in the second film coating device 46 that is disposed on the transport path portion R4b so as to keep the thermal head 71 away from the platen roller 65 and not to generate heat from the heater portion 75. Note that, in the film coating devices 46, the first transport rollers 61, the second transport rollers 62, and the platen rollers 65 are rotated, so that the recording paper can be transported.

When the recording paper that is being transported reaches the first film coating device 46 that is disposed on the transport path portion R4a, the sensor 81 detects the leading edge of the recording paper. When the sensor 81 detects the leading edge of the recording paper, the coating control portion 104 controls the driving of the motor of the take-up reel 67 so that the moving speed of the coating film 70 is set to match the recording paper transport speed. Furthermore, the coating control portion 104 obtains the sliding contact start timing and the sliding contact end timing of the logo region in the document image that has been copied on the recording paper with respect to the heat generating members of the thermal head 71, based on the timing at which the sensor 81 detects the leading edge of the recording paper and the position in the sub-scanning direction of the logo region in the document image, and selectively obtains the heat generating members of the thermal head 71 that overlap the logo region in the document image that has been copied on the recording paper, based on the position in the main-scanning direction of the logo region in the document image. Then, the coating control portion 104 causes only the selected heat generating members of the thermal head 71 to generate heat only in the period from the sliding contact start timing to the sliding contact end timing. Accordingly, when the logo region in the document image that has been copied on the recording paper is passing through a point between the thermal head 71 and the platen roller 65, the coating resin layer of the coating film 70 is brought into close contact only with the logo region in the recording paper, and only the logo region in the recording paper is subjected to resin coating (step S216).

Also in this step, in the case where the original document image and the recording paper have the same size, and the position of the logo region in the original document image matches the position of the logo region in the recording paper, this position of the logo region in the original document image is used to selectively obtain the sliding contact start timing and the sliding contact end timing of the logo region with respect to the heat generating members of the thermal head 71, and the heat generating members of the thermal head 71 that overlap the logo region. Furthermore, in the case where the original document image is copied on the recording paper by the image forming apparatus 1 after magnification or reduction, the position of the logo region in the recording paper is obtained based on the position of the logo region in the original document image and the ratio of the document image magnified or reduced, and this position of the logo region in the recording paper is used to selectively obtain the sliding contact start timing and the sliding contact end timing of the logo region with respect to the heat generating members of the thermal head 71, and the heat generating members of the thermal head 71 that overlap the logo region.

This recording paper is transported from the coating unit 3 to the aftertreatment unit 4. Since the aftertreatment control portion 106 of the aftertreatment unit 4 has received the instruction to keep the stapling device 57 in a stopped state from the main control portion 111, the recording paper is discharged via the discharge transport path R5 to the paper discharge tray 53.

In this manner, in the printing system Ps of this embodiment, the recording paper on which the document image has been copied is set again in the image forming apparatus 1, and resin coating is additionally performed on a partial region (logo region) of the recording paper excluding the resin-coated region (photograph region). Accordingly, resin coating is not repeatedly performed on the same region of the recording paper, and the image quality does not deteriorate.

Note that, instead of using the broken line hb to display the photograph region ha in an identifiable manner on the document image H displayed on the screen 126a of the crystal display device 126 as shown in FIGS. 11 and 12, it is possible to display the photograph region ha as a grayed out region on the document image H as shown in FIGS. 14 and 15.

Furthermore, the image forming apparatus 1 may have a configuration in which a contact image sensor (CIS) that reads a document image on a recording paper placed on the manual feed tray 19 is disposed at a position near the registration rollers 34 or the like, the document image on the recording paper read by the CIS and a document image read from the storage device 113 are compared with each other, the front and back and the orientation of the document image on the recording paper are determined based on this comparison, and, based on this determination result, one film coating device 46 that can perform resin coating on the document image on the recording paper is specified, and the execution timing for the film coating device 46 to perform resin coating on the logo region in the recording paper is obtained.

Furthermore, although the foregoing embodiment applies to resin coating (gloss finish treatment) that is performed on a recording paper using a coating film, the present invention can be applied also to a printing apparatus in which gloss finish treatment is performed on a recording paper using clear toner.

Above, a preferred embodiment of the present invention was described with reference to the appended drawings, but of course the invention is not limited by those examples. It will be clear to those skilled in the art that within the range described in the claims, various modified or revised examples can be arrived at, and it will be understood that such examples also are naturally encompassed by the technical scope of the invention.

1. A printing apparatus that performs gloss finish treatment on at least a partial region of paper on which an image has been printed, comprising a gloss finish treatment adding portion that, when subsequently performing gloss finish treatment on the paper, additionally performs gloss finish treatment on a partial region of the paper excluding any gloss-finished region.

2. The printing apparatus according to claim 1, wherein the gloss finish treatment adding portion has a storage portion that stores data of the gloss-finished region of the paper and a designation portion that designates a partial region of the paper excluding the gloss-finished region in the data in the storage portion, and additionally performs gloss finish treatment on the partial region of the paper designated by the designation portion.

3. The printing apparatus according to claim 2, wherein the gloss finish treatment adding portion has a display portion that displays an image of the paper such that the gloss-finished region of the paper is displayed in an identifiable manner in the image.

4. The printing apparatus according to claim 3, wherein the designation portion is operated to designate a partial region of the paper excluding the gloss-finished region in the image displayed on the display portion.

5. The printing apparatus according to claim 2, wherein the gloss finish treatment adding portion issues a warning in a case where the region of the paper designated by the designation portion overlaps the gloss-finished region of the paper.

6. The printing apparatus according to claim 3, wherein the gloss finish treatment adding portion issues a warning in a case where the region of the paper designated by the designation portion overlaps the gloss-finished region of the paper.

7. The printing apparatus according to claim 4, wherein the gloss finish treatment adding portion issues a warning in a case where the region of the paper designated by the designation portion overlaps the gloss-finished region of the paper.

8. The printing apparatus according to claim 2, wherein the gloss finish treatment adding portion prohibits the designation by the designation portion in a case where the region of the paper designated by the designation portion overlaps the gloss-finished region of the paper.

9. The printing apparatus according to claim 3, wherein the gloss finish treatment adding portion prohibits the designation by the designation portion in a case where the region of the paper designated by the designation portion overlaps the gloss-finished region of the paper.

10. The printing apparatus according to claim 4, wherein the gloss finish treatment adding portion prohibits the designation by the designation portion in a case where the region of the paper designated by the designation portion overlaps the gloss-finished region of the paper.

11. The printing apparatus according to claim 3, wherein the gloss finish treatment adding portion displays a set position and/or a set direction of the paper in the printing apparatus on the display portion.

12. The printing apparatus according to claim 4, wherein the gloss finish treatment adding portion displays a set position and/or a set direction of the paper in the printing apparatus on the display portion.

13. The printing apparatus according to claim 1, wherein, when subsequently performing gloss finish treatment on the paper, the printing apparatus stops image printing on the paper.
